(19) United States
(12) Patent Application Publication
(10) Pub. No.: US 2007/0004472 A1
(43) Pub. Date: Jan. 4, 2007

(54) Method and apparatus for wireless audio management

(76) Inventor: Thomas E. Gitzinger, Palatine, IL (US)

Correspondence Address: INGRASSIA FISHER & LORENZ, P.C., 7150 E. CAMELBACK, STE. 325, SCOTTSDALE, AZ, 85251, US

(21) Appl. No.: 11/170,976

(22) Filed: Jun. 30, 2005

(51) Int. Cl. H04M 1/00

(52) U.S. Cl. 455/575.2

(57) ABSTRACT

A method and apparatus is provided for wireless audio management in a communication system (100). A wireless audio manager (110) includes one or more headphone receptacles (160) for coupling a conventional headset (120) thereto, a wireless receiver (204) for receiving streaming audio information from one or more information devices (130, 140, 150) wirelessly broadcasting streaming audio information, a user interface (170) for receiving user inputs, and a controller (208) coupled to the headphone receptacle(s) (160), the wireless receiver (204) and the user interface (170) for coupling the streaming audio information to the conventional headset (120) by providing the streaming audio information to the headphone receptacle(s) (160) in response to the user inputs.

### FIELD OF THE INVENTION

The present invention generally relates to wireless audio systems, and more particularly relates to a method and apparatus for managing multiple audio devices in a wireless audio system.

### BACKGROUND OF THE INVENTION

Most information devices which provide streaming audio such as cellular telephones, televisions or stereo audio players require the user to audibly communicate with the device (i.e., receiving audible output from a television or a stereo) or directly connect to the information device with a headset for individual reception of the streaming audio. With the advent of Bluetooth™ wireless communication technology, low cost, low power consuming, short-range wireless communication can be used to connect various information devices to a user for individual reception of the streaming audio. One application disclosed in US Patent Application Publication No. US2004/0063459A1 allows a user to couple a wireless headset to an audio source such as a stereo or television. However, such application requires a user to purchase a wireless headset designed for the specific purpose. A user who wants to receive such streaming audio from multiple devices may be required to purchase multiple headsets or purchase specific information devices usable with the wireless headset.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a depiction of a communication system in accordance with an embodiment of the present invention;

FIG. 2 is a block diagram of a wireless audio management unit of the communication system of FIG. 1 in accordance with the embodiment of the present invention;

FIG. 3 is a block diagram of a wireless transmitter of the communication system of FIG. 1 in accordance with the embodiment of the present invention; and

FIG. 4 is a flow chart of the operation of the wireless audio management unit of FIG. 2 in accordance with the embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to wireless audio management. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of wireless audio management described herein. The non-processor circuits may include, but are not limited to, a radio receiver, a radio transmitter, signal drivers, clock circuits, power source circuits, and user input devices. As such, these functions may be interpreted as steps of a method to perform wireless audio management. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method and apparatus is provided for wireless communication. An apparatus in accordance with the present invention includes one or more headphone receptacles for coupling a conventional headset thereto, a wireless receiver for receiving streaming audio information from one or more information devices wirelessly broadcasting streaming audio information, a user interface for receiving user inputs, and a controller coupled to the headphone receptacle(s), the wireless receiver and the user interface for coupling the streaming audio information to the conventional headset by providing the streaming audio information to the headphone receptacle(s) in response to the user inputs. The headphone receptacles, for example, could be a 3.5 mm headset jack, a 2.5 mm headset jack or either of the above or an equivalent for receiving a stereo headset plug. The wireless receiver is preferably a short range wireless protocol receiver, such as a Bluetooth™ receiver, for receiving streaming audio information from a television set top box, an audio player or a wireless communication device, or an equivalent.

The apparatus also includes a wireless transmitter coupled to the controller for transmitting wireless audio information from the apparatus and a microphone for receiving user audio input, the microphone also coupled to the controller and can provide wireless audio information to the wireless communication device. The user interface may receive user control inputs for controlling the wireless communication device where the wireless transmitter is coupled to the controller for broadcasting the user control inputs to the wireless communication device for control thereof. The user interface also includes a display for presenting information to the user.

Alternatively, a wireless audio management unit in accordance with the present invention can be connected to a conventional headset and can wirelessly couple to wireless information devices. The wireless audio management unit includes headphone receptacles for coupling the conventional headset thereto, a wireless receiver for receiving streaming audio information from the wireless information devices, a user interface for receiving user inputs, and a controller coupled to the headphone receptacles, the wireless receiver and the user interface for coupling the streaming audio information to the conventional headset by providing the streaming audio information to the headphone receptacles in response to the user inputs.

The wireless receiver can be, for example, a short range wireless protocol receiver such as a Bluetooth receiver for receiving streaming audio information broadcast from the wireless information devices as radio frequency (RF) signals. The wireless audio management unit may also include a short range wireless protocol transmitter and the user interface may include a microphone coupled to the transmitter for providing user audio information thereto to permit communication with a similarly-enabled telephone, such as a cellular telephone, capable of transmitting and receiving short range wireless protocol RF signals. The controller can maintain a connection with the telephone while receiving audio information from another one of the wireless information devices and providing that audio information to the conventional headset. In fact, the controller can maintain connection with two or more of the wireless information devices simultaneously while providing streaming audio to the at least one headset receptacle from only one of the plurality of wireless information devices.

The user interface further includes a display coupled to the controller for providing status and control information to the user and one or more user-actuable buttons coupled to the controller for receiving control inputs from the user for controlling one or more of the wireless information devices.

A method in a wireless audio management unit in accordance with the present invention which is coupleable to a conventional headset and capable of wirelessly coupling to a plurality of wireless information devices includes the steps of receiving streaming audio information from a first one of the plurality of wireless information devices, receiving a user input requesting selecting a second one of the plurality of wireless information devices for receiving streaming audio from, and controlling a receiver of the wireless audio management unit to switch from receiving the first one to the second one of the plurality of wireless information devices. When the first one of the plurality of wireless information devices is a telephone and the second one of the plurality of wireless information devices is an audio only broadcast device, the step of controlling the receiver of the wireless audio management unit could include the steps of controlling the receiver of the wireless audio management unit to switch from receiving the first one to the second one of the plurality of wireless information devices and muting a microphone of the wireless audio management unit.

The following detailed description of the invention is merely exemplary in nature and is not intended to limit the invention or the application and uses of the invention. Furthermore, there is no intention to be bound by any theory presented in the preceding background of the invention or the following detailed description of the invention.

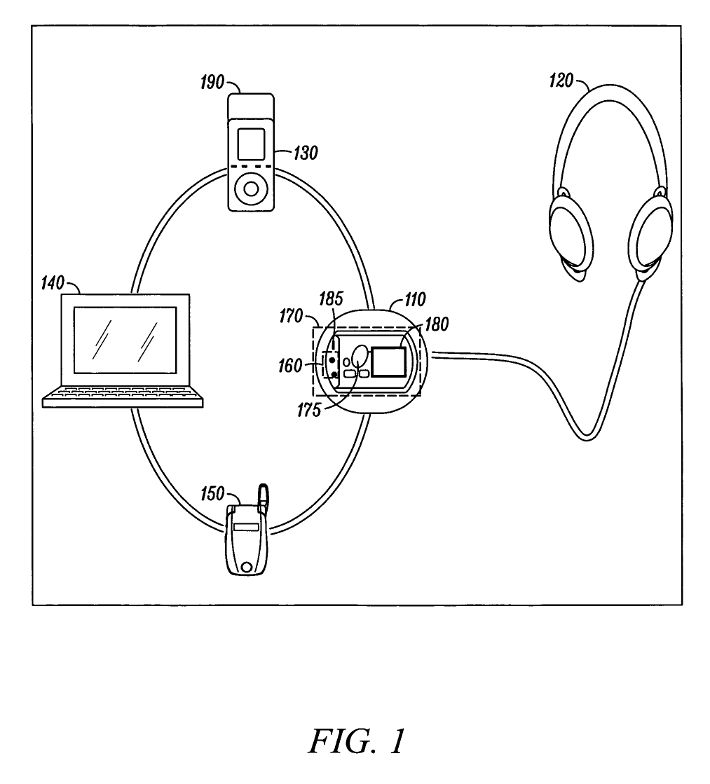

Referring to FIG. 1, a communication system 100 in accordance with an embodiment of the present invention comprises a wireless audio management (WAM) unit 110 for management of wireless communication. The WAM unit 110 is coupled to a conventional headset 120 and is wirelessly coupled to a plurality of wireless information devices such as an audio player 130, a set top box for receiving audio from a television 140, and a Bluetooth-enabled phone 150, such as a cellular telephone.

The WAM unit 110 is a short range wireless protocol device with multipoint capability, such as a Class I or Class II Bluetooth™ device, and is designed to seamlessly receive streaming audio over the short range wireless protocol radio protocol channels and manage the plurality of wireless information devices. By making use of various standard and custom profiles, the WAM unit 110 can, for example, receive streaming stereo audio, mono audio for a cell phone call, or can be used as a remote control for other similarly enabled devices.

The WAM unit 110 would primarily be a receiver. In accordance with the present invention, the WAM unit 110 includes receptacles 160 for coupling the conventional headset 120 thereto, such as a 3.5 mm stereo headset jack and a 2.5 mm jack for plugging the headset 120 thereto. As headsets may be chosen for various reasons, such as, comfort, performance, noise attenuation, or cost, a user of the WAM unit 110 can advantageously use their preferred headset 120.

The WAM unit also includes a user interface 170, including one or more user actuable keys 175 for receiving inputs from the user, a display 180 for presenting information to the user, and a microphone 185 for receiving audio input from the user. With this combination of components, standard stereo headphones 120 could be use as a Bluetooth headset by utilizing the microphone 185 in the WAM unit 110 and clipping the WAM unit 110 onto a shirt collar.

A WAM transmitter 190 would be needed for devices which do not have Bluetooth to convert those devices to wireless information devices. The WAM transmitter 190 would plug into the headset jack of an audio device 130, like an iPod or CD/mp3 player, for providing short range wireless connectivity thereto.

The WAM unit 110 could then be paired with a cell phone 150, a set top box 140, and an iPod™ 130 (attached to a short range wireless transmitter 190). When a user arrives home, he may be listening to his iPod 130, which is in his coat pocket. At home, the user wants to watch a movie on the television 140, but his baby is sleeping. The user can change the WAM unit 110 to receive the audio from the television 140 sound system by a couple of key presses of the keys 175. If the user then remembers that he needs to make a quick call, and, when reaching for his cell phone realizes that he left it in the car, the user can, with a few key 175 presses, pause the movie and switch the WAM unit 110 over to the cellular telephone 150 to make the call. Once the call is finished, the user can switch back to the movie and resume playing. All this can advantageously be done with the WAM unit 110 without requiring the user to get up from his comfortable recliner.

The present invention allows the user to be connected to multiple wireless information devices at the same time while activating only one such information device. For example, if a user can be simultaneously connected to the telephone 150 and connected to the stereo audio device 130. While the user is listening to music from the audio device 130, someone calls the cellular telephone 150. The telephone 150 will notify the WAM unit 110 that an incoming call is detected. The WAM unit 110 can then issue an audio alert overriding the stereo source so the user has some audio indication of an incoming phone call, even if the telephone 150 is in the car. The user can then choose to answer the phone call from the WAM unit and the WAM unit switches to the telephone 150 audio.

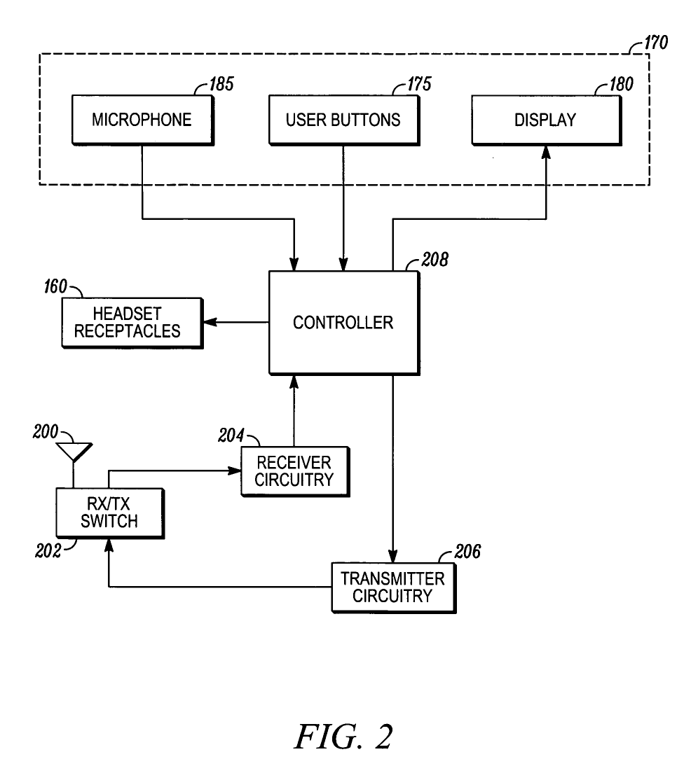

Referring to FIG. 2, the WAM unit 110 includes an antenna 200 for receiving and transmitting short range wireless protocol radio frequency (RF) signals, such as Class I or Class II Bluetooth™ radio frequency (RF) signals. A receive/transmit switch 202 selectively couples the antenna 200 to receiver circuitry 204 and transmitter circuitry 206 in a manner familiar to those skilled in the art. The receiver circuitry 204 demodulates and decodes the RF signals to derive audio information and control signals therefrom and is coupled to a controller 208 for providing the information thereto. The controller 208 is coupled to the headset receptacle(s) 160 for providing the audio information to the conventional headset 120.

The controller 208 also provides information received from the user interface 170, such as audio information received from the microphone 185 or control information received from the user keys 175, to the transmitter circuitry 206 for encoding and modulating information into short range wireless protocol RF signals for broadcasting from the antenna 200. Thus a user could remotely control a wireless information device from the user keys 175 by providing user control inputs thereto. The controller 208 is also coupled to a display 216 for presenting status and control information thereon.

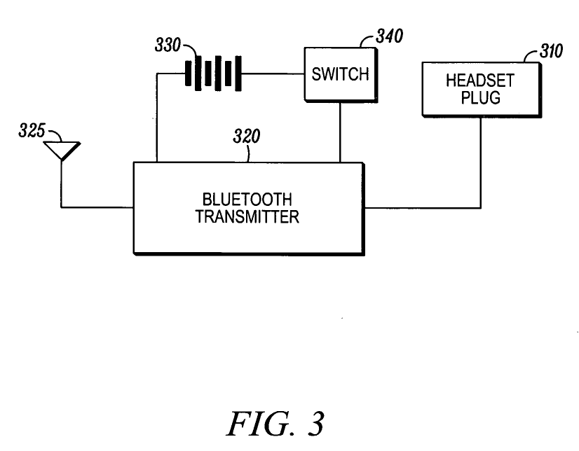

Referring to FIG. 3, a WAM transmitter 190 would consist of a headset plug 310, such as a 3.5 mm headset plug, for coupling the information device thereto, a short range wireless protocol RF transmitter 320 coupled to an antenna 325, a power source 330 for the transmitter 320, and an on/off button 340 for enabling the transmitter. Instead of a separate power source, the WAM transmitter 190 could alternatively share the power source of the information device it is coupled to.

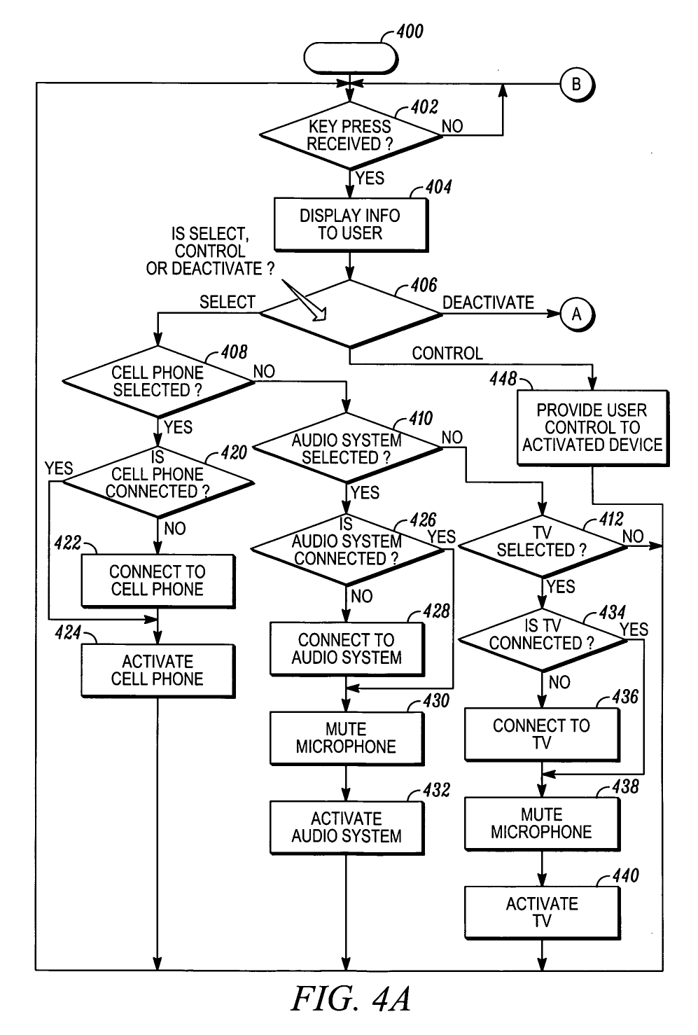

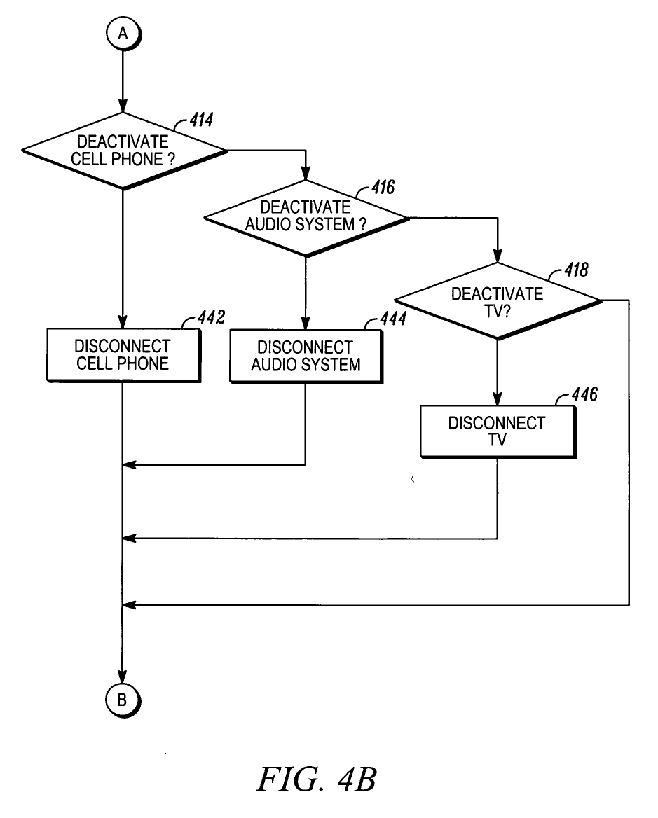

Referring to FIG. 4, a flowchart of the operation of the controller 208 begins 400 with the controller 208 waiting for a user key press 402. When a user key press is received 402, information is displayed to the user 404 identifying the user key press and/or advising the user of the status of the wireless audio management unit 110 and the key press is determined 404 whether it is a wireless information device select command, a wireless information device deactivate command, or an activated device control command.

If the key press 402 selects a wireless information device 406, it is determined whether the cellular telephone 150 is chosen 408, the audio system 130 is chosen 410, or the television set top box 140 is chosen 412. As the controller 208 can maintain connection with two or more of the wireless information devices simultaneously while only providing streaming audio to the headset 120 from only one, the key press 402 could deactivate 406 a wireless information device and it is determined whether the cellular telephone 150 is deactivated 414, the audio system 130 is deactivated 416, or the television set top box 140 is deactivated 418.

If the cellular telephone 150 is chosen 408, it is determined whether the telephone is already connected 420. If the cellular telephone 150 is not connected 420, the controller 208 connects 422 the WAM unit 110 to the cellular telephone 150 and then switches 424 to cellular telephone operation by activating the headset receptacle 160 and the microphone 185 to provide audio to the headphones 120 and receive audio from the user, respectively. Processing then returns to await the next key press 402. If the telephone is already connected 420, the controller switches 424 to the cellular telephone operation by activating the headset receptacle 160 and the microphone 185 and processing returns to await the next key press 402.

If the audio system 130 is chosen 410, it is determined whether the audio system is already connected 426. If the audio system 130 is not connected 426, the controller 208 connects 428 the WAM unit 110 to the audio system 130 and then switches to audio system operation by muting 430 the microphone 185 and activating 432 the headset receptacle 160 to provide the audio system audio to the headphones 120. Processing then returns to await the next key press 402. If the audio system is already connected 426, the controller switches to the audio system operation by muting 430 the microphone 185 and activating 432 the headset receptacle 160 and processing returns to await the next key press 402.

If the television set top box 140 is chosen 412, it is determined whether the television is already connected 434. If the television is not connected 434, the controller 208 connects 436 the WAM unit 110 to the television set top box 140 and then switches to television operation by muting 438 the microphone 185 and activating 440 the headset receptacle 160 to provide the television audio to the headphones 120. Processing then returns to await the next key press 402. If the television is already connected 434, the controller switches to the television operation by muting 438 the microphone 185 and activating 440 the headset receptacle 160 before returning processing to await the next key press 402.

If the cellular telephone 150 is selected to be deactivated 414, the telephone is disconnected 442, and processing returns to await the next key press 402. If the audio system 130 is selected to be deactivated 416, the audio system is disconnected 444 and processing returns to await the next key press 402. And if the television is selected to be deactivated 414, the television set top box 140 is disconnected 442, and processing returns to await the next key press 402.

If the key press 402 is an activated device control command 406, the control command is provided to the activated device 448 for control of the operation thereof. For example, if the user is dialing a telephone number for the cellular phone, the number is provided to the cellular phone for setting up a call therefrom. Alternatively, the key press could pause a movie on the television or switch songs on the audio system.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An apparatus for management of wireless communication coupleable to a conventional headphone comprising:
at least one headphone receptacle for coupling the conventional headset thereto;
a wireless receiver for selectively receiving desired streaming audio information from a first information device providing first streaming audio information to a user and adapted to function as a first short range wireless protocol radio frequency (RF) information device to additionally wirelessly broadcast said first streaming audio information and a second information device providing second streaming audio information to a user and adapted to function as a second short range wireless protocol RF information device to additionally wirelessly broadcast said second streaming audio information;
a user interface for receiving user inputs; and
a controller coupled to the at least one headphone receptacle, the wireless receiver and the user interface for coupling the desired streaming audio information to the conventional headset by providing the desired streaming audio information to the at least one headphone receptacle in response to the user inputs.

2. The apparatus of claim 1 wherein the wireless receiver is a Bluetooth™-enabled RF receiver for receiving Bluetooth RF signals.

3. The apparatus of claim 1 wherein the first and second information devices include a short range wireless protocol RF enabled telephone.

4. The apparatus of claim 1 wherein the first and second information devices include a short range wireless protocol RF enabled digital audio device.

5. The apparatus of claim 1 wherein the first and second information devices include a short range wireless protocol RF enabled television set top box.

6. The apparatus of claim 1 wherein the at least one headphone receptacle comprises a 3.5 mm headset jack.

7. The apparatus of claim 1 wherein the at least one headphone receptacle comprises a 2.5 mm headset jack.

8. The apparatus of claim 1 further comprising a wireless transmitter coupled to the controller for transmitting wireless audio information from the apparatus, and wherein the user interface comprises a microphone for receiving user audio input, the microphone coupled to the controller.

9. The apparatus of claim 8 wherein the wireless receiver receives streaming audio from the first and second information devices, and wherein the wireless transmitter provides wireless audio information to at least one of the first and second information devices.

10. The apparatus of claim 9 wherein the user interface receives user control inputs for controlling at least one of the first and second information devices, and wherein the wireless transmitter is also coupled to the controller for broadcasting the user control inputs to the at least one of the first and second information devices for control thereof.

11. The apparatus of claim 1 wherein the user interface comprises a display for presenting information to the user.

12. A wireless audio management unit for coupling to a conventional headset and for wirelessly coupling to a plurality of wireless information devices via short range wireless radio frequency (RF) signals, each of the plurality of wireless information devices providing streaming audio information to a user as audio signals and additionally providing the streaming audio information as short range wireless RF signals, the wireless audio management unit comprising:
at least one headphone receptacle for coupling the conventional headset thereto;
a wireless receiver for selectively receiving desired streaming audio information as short range wireless RF signals from one or more of the plurality of wireless information devices;
a user interface for receiving user inputs; and
a controller coupled to the at least one headphone receptacle, the wireless receiver and the user interface for coupling the desired streaming audio information to the conventional headset by selecting and providing the desired streaming audio information to the at least one headphone receptacle in response to the user inputs.

13. The wireless audio management unit of claim 12 wherein the plurality of wireless information devices broadcast streaming audio information as Bluetooth™ RF signals, and wherein the wireless receiver is a Bluetooth receiver.

14. The wireless audio management unit of claim 12 further comprising a short range wireless protocol RF transmitter, and wherein the user interface comprises a microphone coupled to the short range wireless protocol RF transmitter for providing user audio information thereto, and wherein the plurality of wireless information devices includes a short range wireless protocol-enabled telephone capable of transmitting and receiving short range wireless protocol RF signals.

15. The wireless audio management unit of claim 14 wherein the telephone is a Bluetooth™-enabled cellular telephone and wherein the controller maintains a connection with the Bluetooth™-enabled cellular telephone while receiving audio information from another one of the plurality of wireless information devices and providing that audio information to the conventional headset.

16. The wireless audio management unit of claim 12 wherein the controller can maintain connection with two or more of the plurality of wireless information devices simultaneously while providing streaming audio to the at least one headset receptacle from only one of the plurality of wireless information devices.

17. The wireless audio management unit of claim 12 wherein the user interface comprises a display coupled to the controller for providing status and control information to the user.

18. The wireless audio management unit of claim 12 wherein the user interface comprises at least one user-actuable button coupled to the controller for receiving control inputs from the user for controlling one or more of the plurality of wireless information devices.

19. A method in a wireless audio management unit coupleable to a conventional headset and capable of wirelessly coupling to a plurality of wireless information devices via short range wireless radio frequency (RF) signals, each of the plurality of wireless information devices providing streaming audio information to a user as audio signals and additionally providing the streaming audio information as short range wireless RF signals, the method comprising the steps of:
receiving streaming audio information as short range wireless RF signals from a first one of the plurality of wireless information devices;
receiving a user input requesting selecting a second one of the plurality of wireless information devices for receiving streaming audio therefrom; and
controlling a receiver of the wireless audio management unit to switch from receiving streaming audio information as short range wireless RF signals from the first one of the plurality of wireless information devices to receiving streaming audio information as short range wireless RF signals from the second one of the plurality of wireless information devices.

20. The method of claim 19 wherein the first one of the plurality of wireless information devices is a telephone and wherein the second one of the plurality of wireless information devices is an audio only broadcast device, and wherein the step of controlling the receiver of the wireless audio management unit comprises the steps of:
controlling the receiver of the wireless audio management unit to switch from receiving the first one to the second one of the plurality of wireless information devices; and
muting a microphone of the wireless audio management unit.
